(19) United States
(12) Patent Application Publication
(10) Pub. No.: US 2014/0214476 A1
(43) Pub. Date: Jul. 31, 2014

(54) DATA INITIALIZATION FOR A SUBTERRANEAN OPERATION

(71) Applicant: Halliburton Energy Services, Inc., Houston, TX (US)

(72) Inventors: Ron Dirksen, Spring, TX (US); Ben Musgrave, Houston, TX (US); Bhargav Hariprasad Patel, Houston, TX (US); Victor Alexander Artiga, Kingwood, TX (US); Cili Sun, Sugar Land, TX (US); Siong Ming Wong, Houston, TX (US)

(73) Assignee: Halliburton Energy Services, Inc., Houston, TX (US)

(21) Appl. No.: 14/165,244

(22) Filed: Jan. 27, 2014

Related U.S. Application Data
(60) Provisional application No. 61/758,869, filed on Jan. 31, 2013.

(51) Int. Cl. G06Q 10/06

(52) U.S. Cl. CPC G06Q 10/06316
USPC 705/7.26

(57) ABSTRACT

An example process for data initialization for a drilling operation may include generating a pre-well job packet for the drilling operation. The pre-well job packet may include at least one of formatted well planning data, contractual data, and equipment data; and may be generated at a first information handling system located remotely from a site of the drilling operation. The pre-well job packet may be received at a second information handling system located at the site of the drilling operation. Data from the pre-well job packet may be automatically imported into a software application of the second information handling system.

### CROSS-REFERENCE TO RELATED APPLICATION

This application claims the benefit of U.S. Provisional Application No. 61/758,869, filed Jan. 31, 2013, which is incorporated herein by reference for all purposes.

### FIELD OF INVENTION

### BACKGROUND

The present disclosure relates generally to downhole drilling operations and, more particularly, to data initialization for subterranean drilling and treatment operations.

Modern subterranean drilling and petroleum production operations are increasing in complexity and require large volumes of data during the on-site operations and throughout the planning process. Planning for and drilling a new well, for example, may require contractual, regulatory, and environmental information, in addition to technical drilling information, including surveying data, well paths, etc. In certain instances, this data may be collected piecemeal, making coordination, processing, and entering the data difficult for well planning personnel as well as on-site field engineers responsible for managing the subterranean operation.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features.

FIG. 1A is a diagram illustrating example data initialization architecture, according to aspects of the present disclosure.

FIG. 1B is a diagram illustrating an example job packet, according to aspects of the present disclosure

FIG. 2 is a diagram illustrating an example data initialization process, according to aspects of the present disclosure.

FIG. 3 is a diagram illustrating an example data initialization process, according to aspects of the present disclosure.

FIG. 4 is a diagram illustrating an example data initialization process, according to aspects of the present disclosure.

FIG. 5 is a diagram of an example information handling system, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to drilling operations that include, but are not limited to, target (such as an adjacent well) following, target intersecting, target locating, well twinning such as in SAGD (steam assist gravity drainage) well structures, drilling relief wells for blowout wells, river crossings, construction tunneling, as well as horizontal, vertical, deviated, multilateral, u-tube connection, intersection, bypass (drill around a mid-depth stuck fish and back into the well below), or otherwise nonlinear wellbores in any type of subterranean formation. Embodiments may be applicable to injection wells, stimulation wells, and production wells, including natural resource production wells such as hydrogen sulfide, hydrocarbons or geothermal wells; as well as borehole construction for river crossing tunneling and other such tunneling boreholes for near surface construction purposes or borehole u-tube pipelines used for the transportation of fluids such as hydrocarbons. Embodiments described below with respect to one implementation are not intended to be limiting.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or local area network (LAN). Thus, if a first device communicatively couples to a second device, that connection may be through a direct connection, or through an indirect communication connection via other devices and connections.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

According to aspects of the present disclosure, a system and process for at least partially automating the collection and entry of data needed for well planning and subterranean operations is described herein. In certain embodiments, the process described herein may include automating or partially-automating the collection and entry of data that may be available for use by an on-site field engineer, who may be responsible for overseeing the implementation of a planned well and the actual drilling process. In certain embodiments, the data may be collected from disparate sources into a data packet, referred to herein as a pre-well job packet, that can be easily and efficiently encrypted and transferred to an on-site field engineer. The pre-well job packet may be created using one or more software applications available to a service coordinator who is responsible for aggregating the required information, and may include data and information in a format accessible by a second software application that outlines and identifies the steps to be taken by on-site personnel, relieving the on-site personnel from the responsibility of manually entering the data. As used herein, a software application may comprise a set of instructions that, when executed by a processor in an information handling system, causes the processor to perform certain functions or actions.

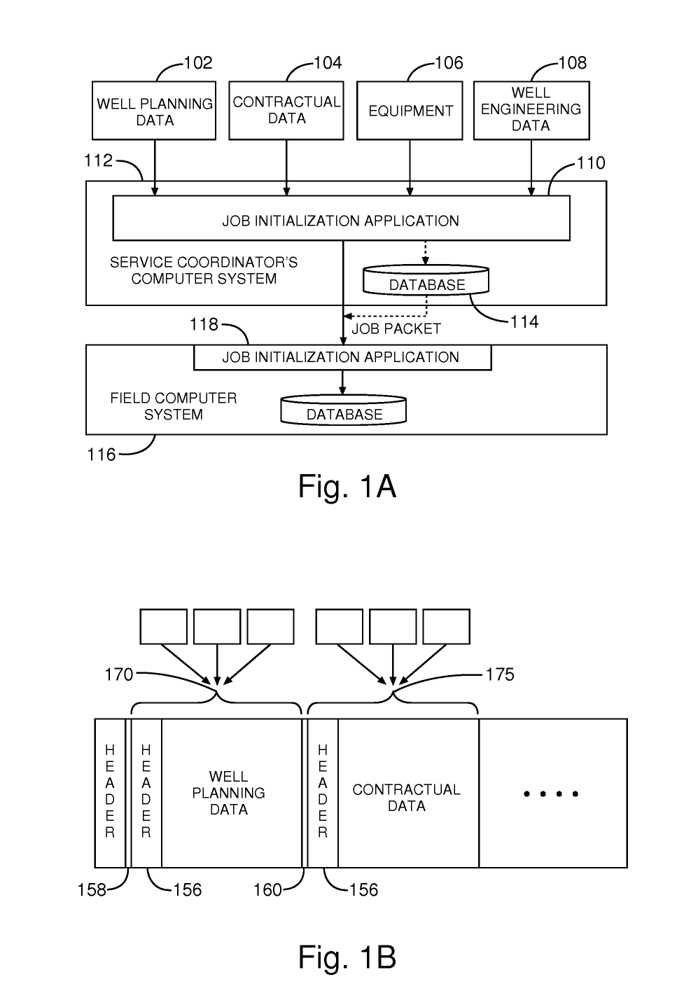

FIG. 1A is a diagram illustrating example data initialization architecture, according to aspects of the present disclosure. As is generally described above, data initialization for a subterranean operation may comprise aggregating data and combining it into a pre-well job packet, which may provide necessary data to personnel for planning and executing a subterranean operation, including subterranean drilling and well treatment operations, in a pre-defined format that is physically or electronically deliverable to personnel at the site of the subterranean operation. In certain embodiments, a pre-well job packet also may comprise one or more electronic files configured to be stored within an information handling system and automatically imported into one or more software applications.

In the embodiment shown, a first information handling system 110 may comprise a job initialization application 112, responsible for creating a pre-well job packet from disparate data types, including at least one of the four identified yet non-limiting types of data—well planning data 102, contractual data 104, equipment data 106, and well engineering data 108. The first information handling system 110 may be located away from the site of a subterranean operation, and may be run by personnel responsible for coordinating operations at the site of the subterranean operation, such as a service coordinator. Once output by the job initialization application 110 and first information handling system 112, the pre-well job packet may be physically or electronically delivered to the site of the subterranean operation, where a second information handling system 116 may be located. The second information handling system 116 may comprise a job initialization application 118 similar to job initialization application 110 that receives the pre-well job packet, parses the information, and imports the information into one or more secondary software application that may display the data. In certain embodiments, the second information handling system 116 may be run by on-site personnel, such as a field engineer, responsible for performing and managing aspects of the subterranean operation.

As described above, the data included in the pre-well job packet may be data necessary to plan and execute the subterranean operation and may comprise many different types of information from many different sources. For example, well planning data 102 may comprise data and information generated and used to plan, drill, or otherwise operate a subterranean well. Subterranean wells may be drilled into underground rock formations, comprising various rock strata, some of which may contain hydrocarbons or other objects of interest. The formation and strata may be surveyed through electromagnetic and seismic means, for example, to determine characteristics of the formation and the location of target formations, where hydrocarbons may be found. Based on the survey data, mathematical models of the formation and strata may be generated, and the course and trajectory of a well necessary to contact the target formation may be generated. Once drilled, the well may be cased to ensure that the well does not collapse. In certain embodiments, the well planning data 102 may comprise elements of the above described information, including, but not limited to, formation surveys, well trajectories, well targets, formation models, and casing information.

In addition to the well planning data described above, contractual data 104 may be important to the subterranean operation and may comprise data regarding contractual obligations related to the drilling operation. In some cases, the right to survey a formation and drill a well requires contractual arrangements, otherwise known as leases, between owners of the land and owners of the mineral rights covering the underground hydrocarbons and those who will be drilling the well. Additionally, subterranean operations may involve equipment rentals, various types of personnel, and other aspects that may require or typically involve contractual obligations. In certain embodiments, the contractual data 104 may comprise elements of the above described information, including, but not limited to, lease information, general well information, and information regarding personnel that will participate in a particular well drilling operation.

Drilling operations typically require multiple types of equipment to drill, survey, and complete a well, and equipment data 106 may comprise data regarding equipment that may be used in the operation. The tools may comprise electromagnetic and acoustic survey tools and various other logging while drilling (LWD) tools, measurement while drilling (MWD) tools that may be positioned near a drill bit to determine characteristics of underground well, drill bits, drill pipe segments, etc. In certain embodiments, equipment data 106 may comprise inventory information regarding some of the above equipment, including the equipment that will be needed, the equipment on-hand, and the equipment that will need to be rented.

Other types of data may be important to well planning and drilling operations, including but not limited to well engineering data 108, regulatory data, and environmental data. Well engineering data 108 may comprise mathematical and physical analysis of aspects of the drilling operation, including analysis of downhole tools (e.g., a bottom hole assembly (BHA)), drill string analysis, hydraulic analysis, bit reamer analysis, drilling performance analysis, as well as fluid design and well bore integrity.

In certain embodiments, at least one of the well planning data 102, contractual data 104, equipment data 106, and well engineering data 108 may be aggregated from multiple sources. For example, data may be automatically generated from database sources or may be generated for the particular well plan by engineers, etc. In certain embodiments, some of the data 102-108 may comprise one or more files or file types that are accepted by a job initialization application 110. For instance, the well planning data 102 may comprise a first file, such as a well plan file, which may comprise an Extensible Markup Language (XML) file exported from a data server, such as an Oracle or SQL data server. In certain embodiments, the exported XML file may be exported from an Engineering Data Model (EDM) for the well plan, and may be generated by a well planner or a separate job coordinator from well planning data stored within a centralized database. In certain embodiments, some or all of the remaining information, including the contractual data 104 and equipment data 106, may be combined into a second file, such as a spreadsheet comprising Contractual or Equipment data extracted from a business data center environment like SAP. A business data center environment may comprise a database containing information regarding contractual relationships, inventory, personnel, etc., that may be queried manually or automatically to provide the desired information. In certain embodiments, the second file may comprise an SAP data export file that is extracted directly from the SAP environment.

The well planning data 102, contractual data 104, equipment data 106, and well engineering data 108, either separately or within the XML and SAP data export files, may be received at the job initialization application 110 running on a first information handling system 112. In certain embodiments, the job initialization application 110 may comprise a pre-well job packet (PWJP) editor. As is described above, the first computer system 112 may be located away from the rig site and run by a service coordinator, who is responsible for generating the pre-well job packet. The service coordinator may verify the accuracy of the well planning data 102, contractual data 104, equipment data 106, and well engineering data 108 using the PWJP editor, and once verified, export the data into a pre-well job packet. This pre-well job packet may then be stored to a centralized database 114 for retrieval by a field engineer, or transmitted or transported in some other manner.

The pre-well job packet may comprise a uniquely encrypted file that can be transferred electronically over a network, or copied to a storage device and transported to the rig site. An on-site field engineer may receive the pre-well job packet. In certain instances, the on-site field engineer may save the pre-well job packet to the second information handling system 116 and import the data from the pre-well job packet into the job initialization application 118. The job initialization application 118 may have similar functionality as the job initialization application 110, and may allow the on-site engineer to examine and validate the data, including comparing the data to existing well planning, contractual, and equipment data stored on a centralized server or database. Once the data has been validated, the pre-well job packet and corresponding data may be saved to a database corresponding to or otherwise imported into a second software application, which may display aspects of the well planning data 102, contractual data 104, equipment data 106, and well engineering data 108 to the field engineer.

One example second software application is a workflow application which displays visual representations of tasks and steps of the subterranean operation to the field engineer. In certain embodiments, the job initialization application 110 may format the well planning data 102, contractual data 104, equipment data 106, and well engineering data 108 into file formats acceptable by the workflow application before creating the pre-well job packet, so that the well planning data 102, contractual data 104, equipment data 106, and well engineering data 108 can be displayed with or incorporated into the visual representations of the tasks and steps of the subterranean operation. Additionally, although the field engineer may verify the accuracy of the data from the pre-well job packet, data importation into the workflow application may be automated, automatically populating the workflow program with the data where necessary. This may dramatically reduce the data entry required by the field engineer and increase the accuracy to the imported data.

FIG. 1B is a diagram illustrating an example pre-well job packet 150 that may be generated by the job initialization application 110, according to aspects of the present disclosure. As illustrated, the packet 150 may comprise consecutive bytes of data combined into a single data file or packet. In the embodiment shown, the packet 150 may comprise a packet header 152 that includes identifying information about the well and/or drilling operation to which the packet corresponds as well as information regarding the contents of the packet. For example the packet header 152 may comprise data regarding the types of information contained in the packet as well as address pointers to the locations of the different types of information within the packet 150.

In the embodiment shown, the packet 150 comprises a first data portion 170 containing well planning data and a second data portion 175 containing contractual data, each saved in contiguous and segregated portions of the packet 150. Each of the data portions 170 and 175 may comprise corresponding headers 154 and 156, respectively. The header 154 may comprise information regarding the contents of the data portion 170, including, in this instance, the types and relative locations of well planning data within the first data portion 170. The header 156 may comprise similar information with respect to the contractual data in the second data portion 175.

The format of the data included in the packet 150 and the format of the packet 150 may be determined by the job initialization application 110, which may contain instructions to format and output data and packets in a particular way. For example, the well planning data may comprise disparate information that is accepted at the job initialization application 110, formatted based on the requirements of a second software application, and combined into a contiguous chunk or portion. The job initialization application 110 may then generate a header of a pre-determined format and append the header to the data. The job initialization application 110 may perform similar actions with respect to the contractual data, before sequentially combining the first and second data portions 170 and 175, generating the packet header 152 of a pre-determined format for the combined information, and appending the packet header 152 to the combined information. After it is generated, the packet 150, being of discrete length, may be encrypted or otherwise secured to prevent unwanted access.

The job initialization application 118 located on site may receive and parse the packet 150 to determine the type and location of data within the packet 150, based on the pre-determined formats of both the packet 150 and the data portions 170 and 175 of the packet 150. For example, the job initialization application 118 may read the packet header 152 to determine that the first data portion 170 is located beginning at a relative location 158 in the packet 150 and that the second data portion 175 is located beginning at a relative location 160 in the packet 150. The job initialization application 118 may then read the header 154, associate data in the first data portion 170 with well planning data, and extract the well planning data from the first data portion based on the contents of the header 154. The job initialization application 118 may perform similar actions with respect to the header 156 and contractual data. Once parsed and extracted, the data may be viewed by a field engineer, for example, or otherwise incorporated into the second software application.

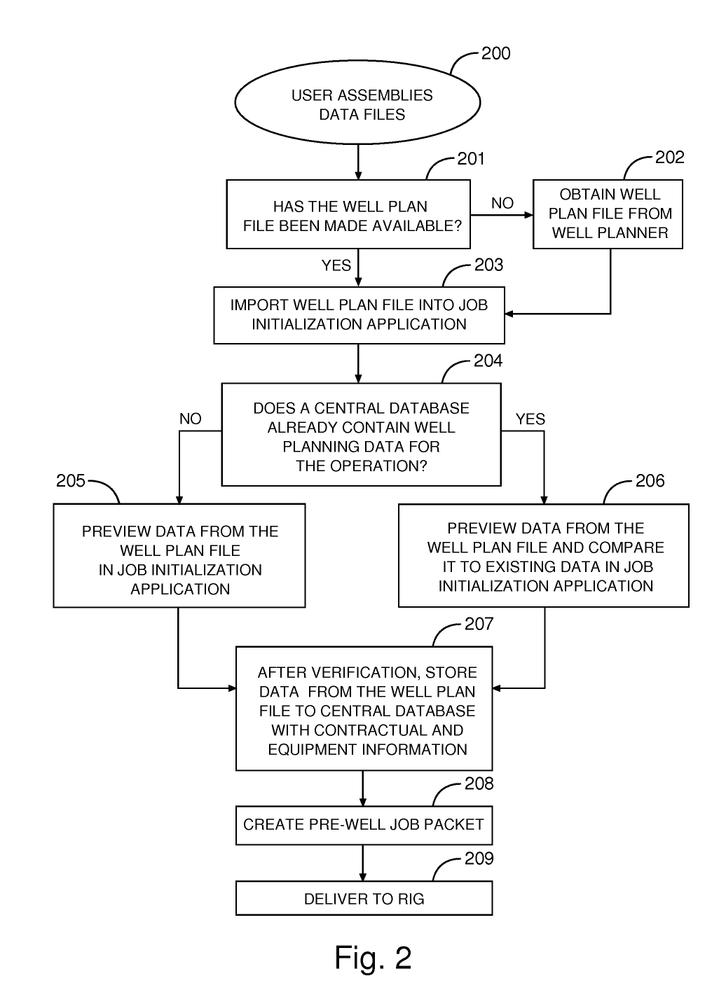

FIG. 2 shows an example flowchart that may be followed to generate a job packet to be delivered to an on-site field engineer, according to aspects of the present disclosure. At step 200, a user, such as a service coordinator, may assemble the data described above from various sources, including a well planner, engineers, business divisions, etc. Assembling the data may include retrieving various data files and storing them to an information handling system so that they can be imported into a job initialization application. At step 201 it is determined whether the well plan file has been made available. As described above, the well plan file may comprise an exported XML file generated by a well planner. If the well plan file has not been made available, it may be obtained from the well planner at step 202 and then imported into the job initialization application at step 203. If the well plan file has been made available, the file can be imported into job initialization application directly at step 203.

At step 204, it may be determined whether a central database accessible by the user already contains well planning data corresponding to the operation. If well planning data does not already exist, the well planning data from the well plan file may be previewed in the job initialization application and verified at step 205 and the verified data saved to the database at step 207. If some well planning data exists in the database, the existing data can be compared to data from the well plan file, the differences identified and verified at step 206, and the new well plan data saved to the database at step 207. The pre-well job packet then may be created at step 208 and delivered to the rig at step 209.

In certain embodiments, the pre-well job packet may only be created when the well planning data, the contractual data, and the equipment data have been verified and stored to the central database. An example process for storing the contractual and equipment information is described below. In certain instances, only some of the data may be available, and an incomplete pre-well job packet may be generated. Later, once all of the data is available, the pre-well job packet may be supplemented or an entire new pre-well job packet may be generated and sent to the rig site.

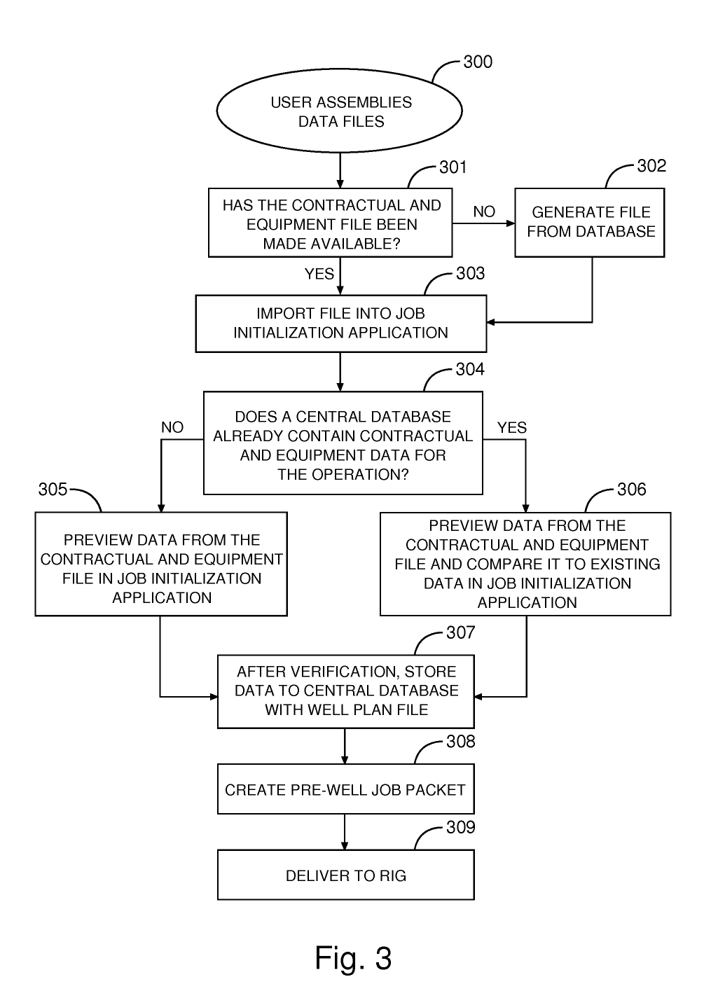

FIG. 3 is a flowchart illustrating the process for aggregating, verifying and storing the contractual and equipment information. The process in FIG. 3 may be performed separately, consecutively, or in parallel with the process in FIG. 2 regarding the well planning data. At step 300, a user may assemble the data described above from various sources, including a well planner, engineers, business divisions, etc. Assembling the data may include retrieving various data files and storing them to an information handling system so that they can be imported into a job initialization application. At step 301, it may be determined whether the file containing the contractual and equipment data has been made available. As described above, the file containing the contractual and equipment data may comprise SAP data export file. If the file is not available, the file may be generated from a database at step 302 and imported into job initialization application at step 303. If the file is available, it may be imported directly at step 303. At step 304 it may be determined whether some contractual or equipment data for the rig operation is already stored in the database. If it is not, the contractual and equipment data from the file may be previewed within the job initialization application and verified at step 305 and the verified data saved to the database at step 307. If some contractual or equipment data for the rig operation is already stored in the database, it can be compared to the contractual or equipment data from the file and the differences can be identified and verified at step 306, and the data saved to the database at step 307. The pre-well job packet may then be generated at step 308 and delivered to the rig at step 309.

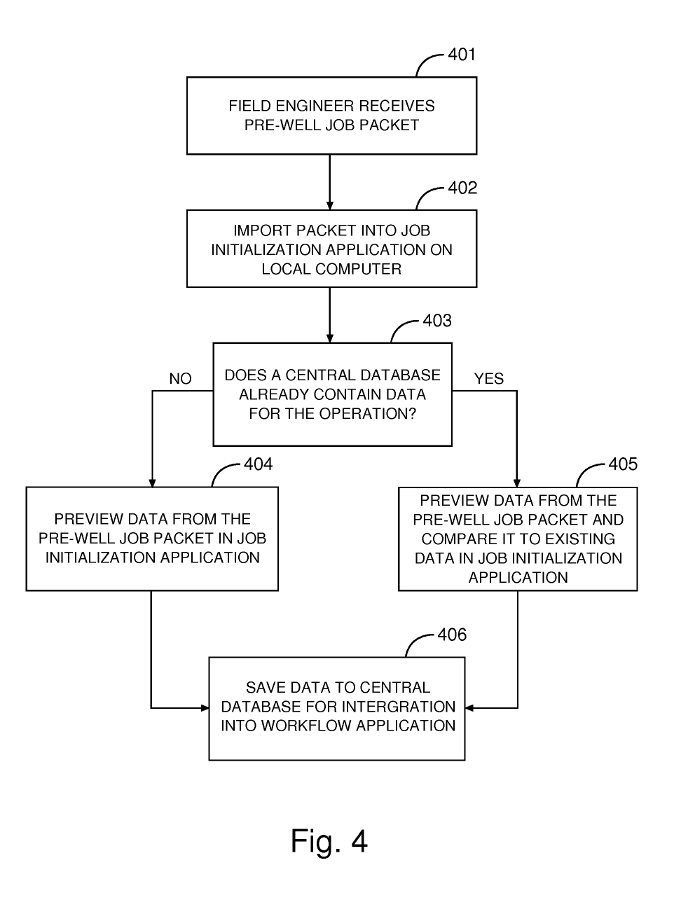

FIG. 4 is a flowchart illustrating example actions which may be taken by a field engineer upon receiving the pre-well job packet generated using the flowcharts above. The field engineer may receive the pre-well job packet at step 401. At step 402 the pre-well job packet may be imported into a job initialization application. Step 403 may include determining whether a central database already contains data for the operation. If the database does not already contain data, the data from the pre-well job packet may be previewed and verified in the job initialization application at step 404. If the database already contains data for the operation, then the data from the pre-well job packet may be compared to the existing data and verified within the job initialization application at step 404. Once verified, the data from the pre-well job packet may be saved to a data for integration into a second software application at step 406.

As described above, the job initialization application may comprise a pre-well job packet editor that includes an interface to identify discrepancies between the existing contractual, equipment, or well plan data and the data received in the pre-well job packet. For example, the editor may place certain data fields from the new and existing data side by side, and allow the field engineer or service coordinator to select the correct data. Additionally, some of the well planning data such as trajectory, target, and casing may have preview plots by which the data can be verified for accuracy. Once the job packet data has been verified and the correct data selected, the contractual and well plan data may be saved to the database as the active data for the particular rig operation to which the field engineer is assigned. If the new data is selected instead of existing data, the existing data may be over-written in a central database. In certain embodiments, the field engineer may be limited regarding the existing data which may be over-written. This data may include, for example, survey data for the rig site, and may protect against erroneous deletion of important data. In certain embodiments, the field engineer may be able to override the data, but only with authorization.

In certain embodiments, parts of the data used to create the pre-well job packet, such as the well planning and contractual data, may be updated while the subterranean operation is underway. This may, for example, prevent erroneous data from being used in the subterranean operation. Once an error is identified or new data is available, a new job packet with the updated information may be created and sent to the field engineer on site. The field engineer may then load the updated job packet into an information handling system located on site, select only the parts of the data that need to be updated, save only those selected parts, and leave the rest of the data unchanged.

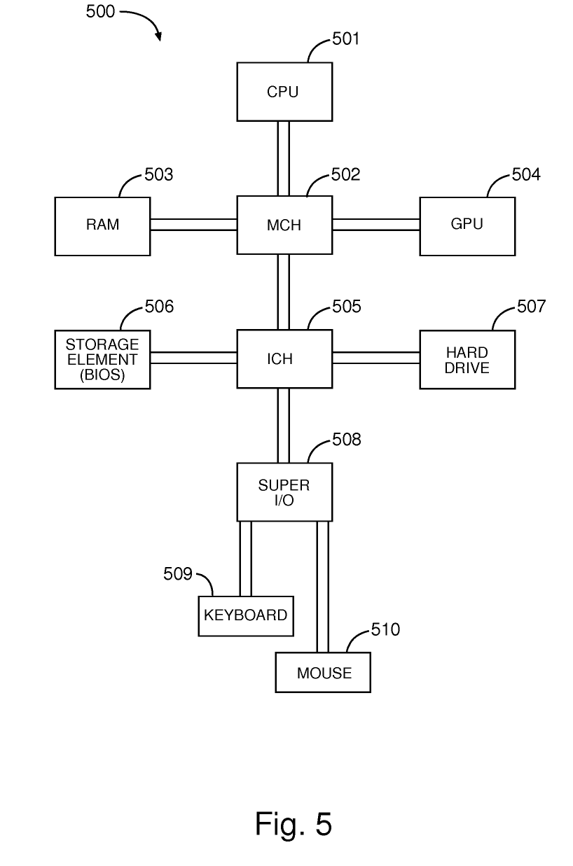

FIG. 5 is a block diagram showing an example information handling system 500, according to aspects of the present disclosure. A processor or CPU 501 of the information handling system 500 is communicatively coupled to a memory controller hub or north bridge 502. Memory controller hub 502 may include a memory controller for directing information to or from various system memory components within the information handling system, such as RAM 503, storage element 506, and hard drive 507. The memory controller hub 502 may be coupled to RAM 503 and a graphics processing unit 504. Memory controller hub 502 may also be coupled to an I/O controller hub or south bridge 505. I/O hub 505 is coupled to storage elements of the computer system, including a storage element 506, which may comprise a flash ROM that includes a basic input/output system (BIOS) of the computer system. I/O hub 505 is also coupled to the hard drive 507 of the computer system. I/O hub 505 may also be coupled to a Super I/O chip 508, which is itself coupled to several of the I/O ports of the computer system, including keyboard 509 and mouse 510.

According to aspects of the present disclosure, an example computer-implemented process for data initialization for a drilling operation may include generating a pre-well job packet for the drilling operation. As used herein, a computer-implemented process may comprise a process or method with one or more steps that is at least partially performed within a computer or information handling system, such as through a software application or instruction set that is executed by a processor. The pre-well job packet may include at least one of formatted well planning data, contractual data, and equipment data; and may be generated at a first information handling system located remotely from a site of the drilling operation. The pre-well job packet may be received at a second information handling system located at the site of the drilling operation. Data from the pre-well job packet may be automatically imported into a software application of the second information handling system.

In certain embodiments, generating the pre-well job packet may comprise receiving the well planning data in an Extensible Markup Language (XML) file exported from a data server. Generating the pre-well job packet may comprise receiving at least one of the contractual and equipment information in an SAP data export file. In certain embodiments, receiving the pre-well job packet may comprise at least one of receiving the pre-well job packet from a database communicably coupled to the second information handling system; and receiving the pre-well job packet from a storage device physically coupled to the second information handling system.

In certain embodiments, generating the pre-well job packet may comprise generating the pre-well job packet at a first job initialization application on the first information handling system. Automatically importing data from the pre-well job packet may comprise parsing the pre-well job packet at a second job initialization application on the second information handling system. In certain embodiments, the well planning data may comprise at least one of a formation survey, well trajectory, well target, and formation model; the contractual data may comprise at least one of lease information and personnel information; and the equipment data may comprise a list of at least some of the equipment to be used during the drilling operation.

Automatically importing data from the pre-well job packet into a software application of the second information handling system may comprise importing data from the pre-well job packet into a workflow visualization program. The process may further include generating graphical visualization that includes data from the pre-well job packet. In certain embodiments, the process may further comprise receiving an updated pre-well job packet at the second information handling system, and updating the software application with data from the updated pre-well job packet.

According to aspects of the present disclosure, an example system for data initialization for a drilling operation may comprise a first information handling system located remotely from a site of the drilling operation. The first information handling system may comprise a first processor and a first memory device coupled to the processor, the first memory device containing a first set of instructions that, when executed by the first processor, cause the first processor to receive at least one of well planning data, contractual data, and equipment data; and generate a pre-well job packet for the drilling operation comprising at least one of formatted well planning data, contractual data, and equipment data. The system may include a second information handling system located at the site of the drilling operation. The second information handling system may comprise a second processor and a second memory device coupled to the processor, the second memory device containing a second set of instructions that, when executed by the second processor, cause the second processor to receive the pre-well job packet; and automatically import data from the pre-well job packet into a workflow application.

The first set of instructions that cause the first processor to receive at least one of well planning data, contractual data, and equipment data may further cause the first processor to receive the well planning data as an Extensible Markup Language (XML) file exported from a data server. The first set of instructions that cause the first processor to receive at least one of well planning data, contractual data, and equipment data may further cause the first processor to receive at least one of the contractual and equipment information in an SAP data export file. The second set of instructions that causes the second processor to receive the pre-well job packet may further cause the second processor to at least one of receive the pre-well job packet from a database communicably coupled to the second information handling system; and receive the pre-well job packet from a storage device physically coupled to the second information handling system.

The first set of instructions that causes the first processor to generate the pre-well job packet for the drilling operation may further cause the processor to generate the pre-well job packet using a first job initialization application. The second set of instructions that causes the second processor to automatically import data from the pre-well job packet may further cause the second process to parse the pre-well job packet using a second job initialization application on the second information handling system. In certain embodiments, the well planning data may comprise at least one of a formation survey, well trajectory, well target, and formation model; the contractual data may comprise at least one of lease information and personnel information; and the equipment data may comprise a list of at least some of the equipment to be used during the drilling operation.

In certain embodiments, the workflow application of the second information handling system may comprise a workflow visualization software application. The second set of instructions may further cause the second processor to generate a graphical visualization that includes data from the pre-well job packet. The second set of instructions may further cause the second processor to receive an updated pre-well job packet; and update the workflow application with data from the updated pre-well job packet.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A computer-implemented process for data initialization for a drilling operation, comprising:
generating a pre-well job packet for the drilling operation, wherein the pre-well job packet
comprises at least one of formatted well planning data, contractual data, and equipment data; and
is generated at a first information handling system located remotely from a site of the drilling operation;
receiving the pre-well job packet at a second information handling system located at the site of the drilling operation; and
automatically importing data from the pre-well job packet into a software application of the second information handling system.

2. The computer-implemented process of claim 1, wherein generating the pre-well job packet comprises receiving the well planning data in an Extensible Markup Language (XML) file exported from a data server.

3. The computer-implemented process of claim 1, wherein generating the pre-well job packet comprises receiving at least one of the contractual and equipment information in an SAP data export file.

4. The computer-implemented process of claim 1, wherein receiving the pre-well job packet comprises at least one of
receiving the pre-well job packet from a database communicably coupled to the second information handling system; and
receiving the pre-well job packet from a storage device physically coupled to the second information handling system.

5. The computer-implemented process of claim 1, wherein generating the pre-well job packet comprises generating the pre-well job packet at a first job initialization application on the first information handling system.

6. The computer-implemented process of claim 5, wherein automatically importing data from the pre-well job packet comprises parsing the pre-well job packet at a second job initialization application on the second information handling system.

7. The computer-implemented process of claim 1, wherein
the well planning data comprises at least one of a formation survey, well trajectory, well target, and formation model;
the contractual data comprises at least one of lease information and personnel information; and
the equipment data comprises a list of at least some of the equipment to be used during the drilling operation.

8. The computer-implemented process of claim 1, wherein automatically importing data from the pre-well job packet into a software application of the second information handling system comprises importing data from the pre-well job packet into a workflow visualization program.

9. The computer-implemented process of claim 8, further comprising generating graphical visualization that includes data from the pre-well job packet.

10. The computer-implemented process of claim 1, further comprising
receiving an updated pre-well job packet at the second information handling system; and
updating the software application with data from the updated pre-well job packet.

11. A system for data initialization for a drilling operation, comprising:
a first information handling system located remotely from a site of the drilling operation, the first information handling system comprising a first processor and a first memory device coupled to the processor, the first memory device containing a first set of instructions that, when executed by the first processor, cause the first processor to
receive at least one of well planning data, contractual data, and equipment data; and
generate a pre-well job packet for the drilling operation comprising at least one of formatted well planning data, contractual data, and equipment data; and
a second information handling system located at the site of the drilling operation, the second information handling system comprising a second processor and a second memory device coupled to the processor, the second memory device containing a second set of instructions that, when executed by the second processor, cause the second processor to
receive the pre-well job packet; and
automatically import data from the pre-well job packet into a workflow application.

12. The system of claim 11, wherein the first set of instructions that cause the first processor to receive at least one of well planning data, contractual data, and equipment data further cause the first processor to receive the well planning data as an Extensible Markup Language (XML) file exported from a data server.

13. The system of claim 11, wherein the first set of instructions that cause the first processor to receive at least one of well planning data, contractual data, and equipment data further cause the first processor to receive at least one of the contractual and equipment information in an SAP data export file.

14. The system of claim 11, wherein the second set of instructions that causes the second processor to receive the pre-well job packet further causes the second processor to at least one of
receive the pre-well job packet from a database communicably coupled to the second information handling system; and
receive the pre-well job packet from a storage device physically coupled to the second information handling system.

15. The system of claim 11, wherein the first set of instructions that causes the first processor to generate the pre-well job packet for the drilling operation further causes the processor to generate the pre-well job packet using a first job initialization application.

16. The system of claim 15, wherein the second set of instructions that causes the second processor to automatically import data from the pre-well job packet further causes the second process to parse the pre-well job packet using a second job initialization application on the second information handling system.

17. The system of claim 11, wherein
the well planning data comprises at least one of a formation survey, well trajectory, well target, and formation model;
the contractual data comprises at least one of lease information and personnel information; and
the equipment data comprises a list of at least some of the equipment to be used during the drilling operation.

18. The system of claim 11, wherein the workflow application of the second information handling system comprises a workflow visualization software application.

19. The system of claim 18, wherein the second set of instructions further causes the second processor to generate a graphical visualization that includes data from the pre-well job packet.

20. The system of claim 11, wherein the second set of instructions further causes the second processor to
receive an updated pre-well job packet; and
update the workflow application with data from the updated pre-well job packet.
